(19) United States
(12) Patent Application Publication
(10) Pub. No.: US 2012/0150862 A1
(43) Pub. Date: Jun. 14, 2012

(54) SYSTEM AND METHOD FOR AUGMENTING AN INDEX ENTRY WITH RELATED WORDS IN A DOCUMENT AND SEARCHING AN INDEX FOR RELATED KEYWORDS

(75) Inventor: Steven J. Harrington, Webster, NY (US)

(73) Assignee: Xerox Corporation, Norwalk, CT (US)

(21) Appl. No.: 12/965,964

(22) Filed: Dec. 13, 2010

(51) Int. Cl. G06F 17/30

(52) U.S. Cl. 707/741; 707/769; 707/E17.014; 707/E17.002

(57) ABSTRACT

A method for enhancing a search of a set of documents is described. The method allows a user to present a word of interest. The word is then matched to related words in a larger corpus of words and the related words are matched against an index of the document to identify words that appear in both the matched words and the document index. The word selected by the user may be taken from a previously generated index of the document or the word may be presented by the user based on a topic of interest.

### BACKGROUND

When searching a document or set of related documents, conventionally an index is used to look up places in the document where a particular term of interest applies. However, indices are often limited and thus the success of an index-based search is dependent on the comprehensiveness of the index.

Furthermore, a particular topic may be of interest, which is covered in a document; however, the specific terms in the document defining that topic may not be known, thus hindering the search for the particular topic.

More specifically, when searching for a topic (word or phrase) within a document, an index can be searched to look up a word related to the topic of interest. However, the document being searched may employ a synonym or other related words, instead of the specifically chosen word. Thus, a manual scan through the index looking for any word that may be related is required.

Moreover, when seeking information in a document or set of documents one can use an index if it is available. One selects a word that is related to the topic of interest, and looks up that word in the index. The problem is that the particular word chosen may not be in the index, while some other related word may have been a better choice.

Thus, it may be desirable to provide a system or method that is able to enter a search query that is more general and have a search mechanism return a list of possible places in the document that may be relevant. Such an expanded search may provide a greater degree of flexibility in searching a document for information about a particular topic.

Moreover, it may be desirable to provide a system or method that is able to allow entry of a search query that may be relevant to the search (particular topic), but is not specifically included in the document so that the search mechanism is enable to find words or phrases in the document which are closely related to the entered search query.

In addition, it may be desirable to provide a system or method that is capable of handling complex potential relationships between a term entered by a user and the actual words in the document wherein the complex relationships may include words that are alternative spellings of terms used in the search query, synonyms for the terms used in the search query, or other relationships.

### BRIEF DESCRIPTION OF THE DRAWING

The drawings are only for purposes of illustrating various embodiments and are not to be construed as limiting, wherein:

FIG. 1 illustrates a system for generating an expanded search of a document;

FIG. 2 illustrates a method for generating an expanded search of a document;

FIG. 3 illustrates another method for generating an expanded search if a document;

FIG. 4 illustrates a display screen showing an index created for documents about skeletal fluorosis;

FIG. 5 illustrates a display screen showing selecting the word “pain” from the index to yield a list of places where “pain” is used in the documents;

FIG. 6 illustrates a display screen showing requesting related words to add a sub-index that contains words related to “pain” that are also within the document set;

FIG. 7 illustrates a display screen showing selecting the related word “burn” to provide places where “burn” is found in the document set;

FIG. 8 illustrates a display screen showing specifying words for the index search;

FIG. 9 illustrates a display screen showing Displaying of words found within the index;

FIG. 10 illustrates a display screen showing references to where the index word “suffering” is found in the document;

FIG. 11 illustrates a display screen showing one of the references that can be selected; and

FIG. 12 illustrates a display screen showing one of the references loaded for review.

### DETAILED DESCRIPTION

For a general understanding, reference is made to the drawings. In the drawings, like references have been used throughout to designate identical or equivalent elements. It is also noted that the drawings may not have been drawn to scale and that certain regions may have been purposely drawn disproportionately so that the features and concepts may be properly illustrated.

In the description that follows reference is made to searching in a document. However the method to be described is not limited to a single document, but is applicable when a set of documents are being searched. Therefore any reference to a document is meant to be equally applicable to a set of documents.

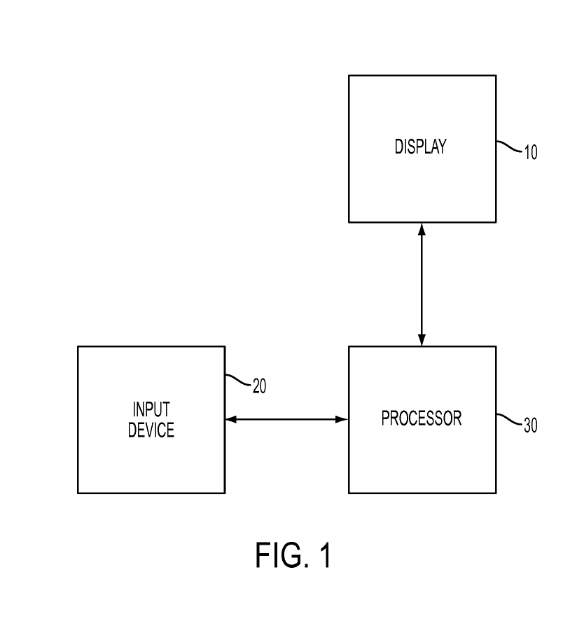

FIG. 1 illustrates a general system that is capable of expanding the search terms for a document set. The system includes an input device 20, such as a keyboard, pointing device, touch screen, or other type of device that allows human interface for inputting information into the system. The system is controlled by a processor 30, which processes the information which is received from the input device 20. The processor 30 may be a personal computer, laptop, or other computing device. The system can display information on a display 10. The system may also output information to a reproduction device such as a printer or to a server, repository, or a local area network, etc.

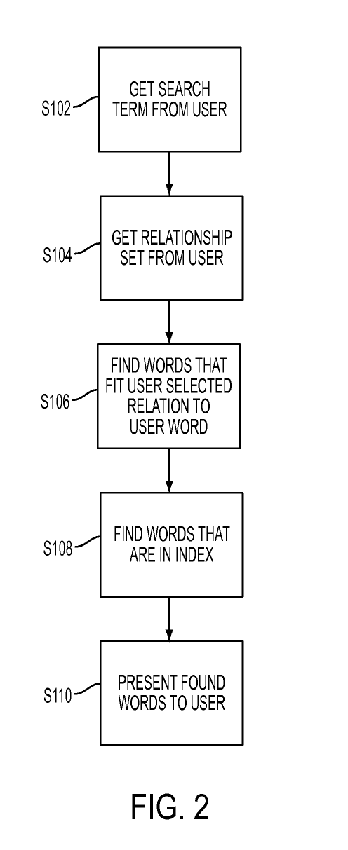

FIG. 2 illustrates a method for expanding the search terms for a document set. In step S102, a search term is received from a user. The search term is related to some topic that may be discussed in the document. The search term may be in the document, or alternatively, terms related to the search term may be in the document. The goal is to maximize the likelihood that the user will find the information, relevant to search, in the document.

In step S104, a set of relationships between the term entered by the user and other potential terms, which may be in the document, is selected by the user. The relationships are chosen from a set of possible relationships that may exist between the user search term and words that may be in the document.

An example of a relationship between words is that words are synonyms of each other. For example, the user may enter “pain” in which case words like “discomfort,” “uncomfortable,” and “distress,” as well as others, may be considered related. Synonyms can be identified using an electronic thesaurus to look up words related as synonyms to the user search word.

Words can have several meanings and this translates into several synonym sets (synsets) supplied by the thesaurus. When doing a document search, all of the synsets are considered because the selection of the most appropriate synset will occur when comparing the words in each synset with those words in the document. For each synset, the synonyms are included in the set of related words, but words related in other ways can also be included.

However, there are more relationship between words than just synonyms. Some examples of relationships between words may include the following:

Synonymy: words that have similar meanings, e.g. happy and glad.

Antonymy: the opposite of synonymy, e.g. happy and sad.

Hypernymy: a hierarchical relationship between words. For example, furniture is a hypernym of chair since every chair is a piece of furniture, but not every piece of furniture is a chair.

Hyponymy: the opposite of hypernymy. Dog is a hyponym of canine since every dog is a canine.

Meronymy: a part/whole relationship. For example, paper is a meronym of book, since paper is a part of a book.

Holonymy: the reverse of meronymy. Tree is a holonym of bark.

Troponymy: the semantic relationship of doing something in the manner of something else. For example, “walk” is a troponym of “move” and “limp” is a troponym of “walk.”

Entailment: the relationship between verbs where doing something requires doing something else. If you are snoring, you must be sleeping so sleeping is entailed by snoring.

Furthermore, homophones, words that sound like the entered term from the user can also be considered.

After a desired set of relationship is obtained, a search is made, at step S106, to identify words in the document that match one or more of the relationships selected, at step S104, to the word entered as a search term, at step S102.

The words that fit a particular relationship to the search term entered, at step S102, are assembled into a synset. Once a complete set of synsets has been assembled, the words in the set of synsets can be compared to words in an index of the document, at step S108.

Those words that appear in both the index and the generated set of words are presented to the user, at step S110. The presented list of words can now be used by the user to find the section of the document that is relevant to the user. The presentation may take the form of a list of words, each word including a hyperlink to the relevant section of the document.

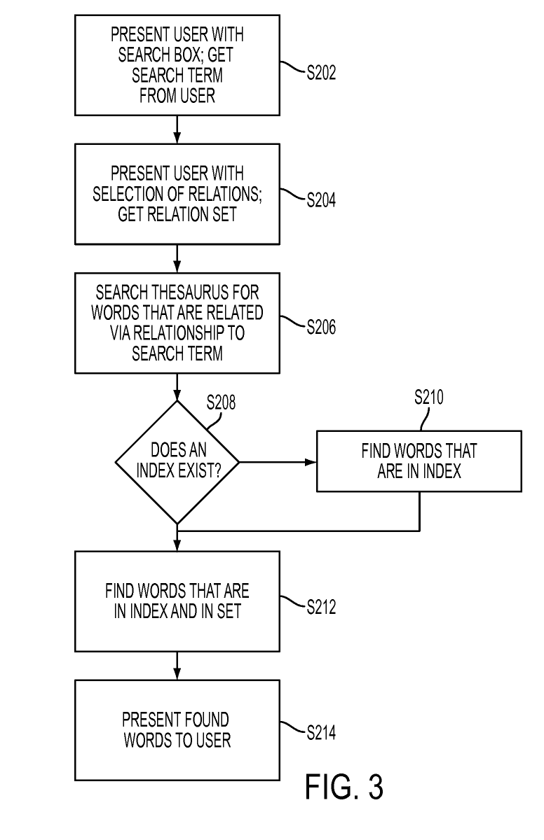

FIG. 3 shows an exemplary embodiment of the method of FIG. 2.

In the embodiment of FIG. 3, a further option is included that generates an index of the document if an index does not already exist.

At step S202, the user is presented with a search box in which the user can enter one or more search words. These words are related to the content of the document from which the user wishes to obtain more information. The entered words may or may not be in the document.

At step S204, the user is presented with a selection box containing a set of selectable relations between the word entered, at step S202, and possible terms in the document. For example, the selection box may list all of the relationships that the method is prepared to use with a selection box next to each of the relationships. By clicking on one or more of the selection boxes, the associated relations are included in the subsequent development of a complete set of search terms. An embodiment of the method can avoid the requirement of a user's selection of relationships by simply including all available relationships in the development of a set of search terms.

At step S206, the thesaurus is searched for words that match each of the relationships chosen, at step S204, and are added to a set of words.

At step S208, a check is made to see if an index of the document exists. If an index does not exist, an index is generated, at step S210. If an index already exists, the method continues at step S212.

At step S212, the words in the set are compared to the words in the index, and the words from the set that are also in the index are assembled into a search list.

At step S214, the search list is presented to the user. Each word in the search list may have a hyperlink or other reference means that links the word to the place in the document where the word occurs. In this manner, the user can select the word, and the part of the document where the selected word occurs is located or presented to the user.

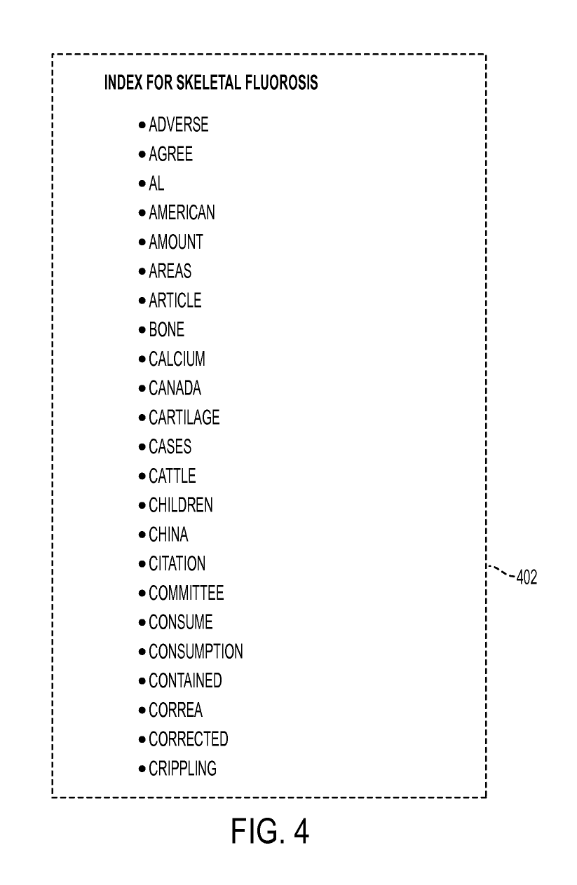

FIG. 4 shows an example of a computer screen 402 corresponding to the embodiment of FIGS. 2 and 3. In the implementation of FIG. 4, a browser-like tool may be used as an interface between the user and the search method. FIG. 4 shows a search being conducted on a document set relating to the medical condition, Skeletal Fluorosis. The display 402 in FIG. 4 shows an index of the document set. A user can select a term from the index to search on.

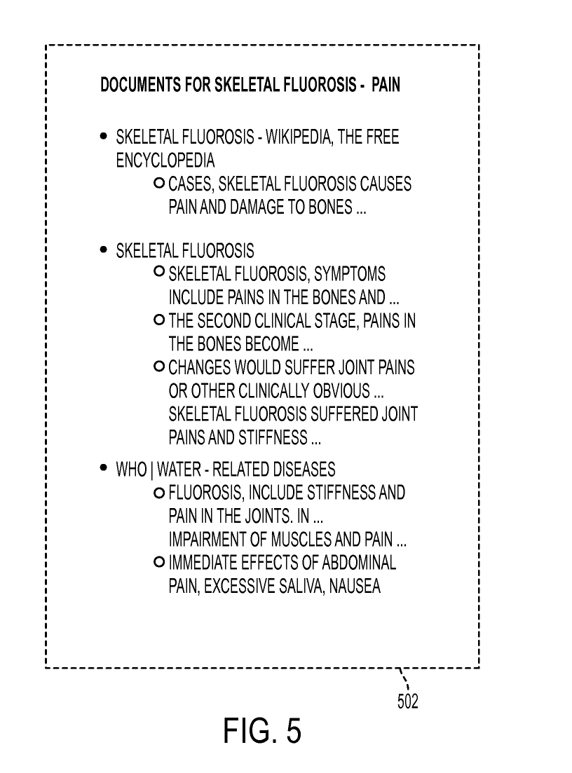

FIG. 5 shows, on a screen 502, what may appear when a user selects the terms “pain” from the display of FIG. 4.

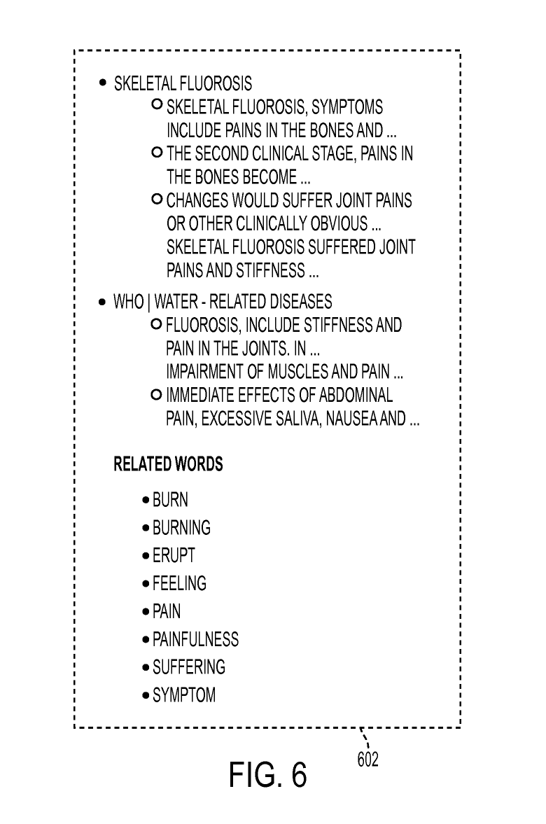

FIG. 6 shows, on a screen 602, a list of words (Related Words), in this case synonyms of “pain” that appear in the document set. A user may now select one of these related words to access parts of the document where the selected word appears.

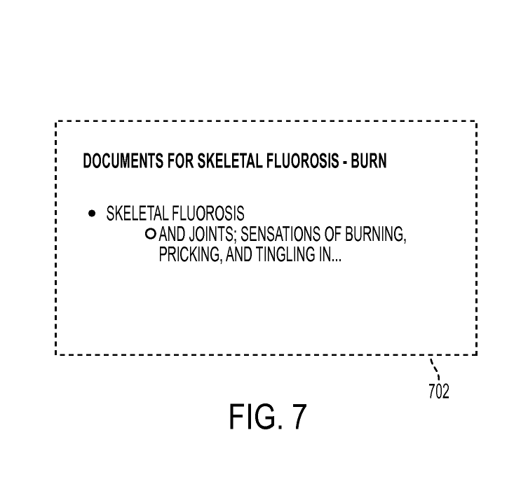

FIG. 7 shows, on a screen 702, the results of selecting the term “burn” from the list presented in FIG. 6.

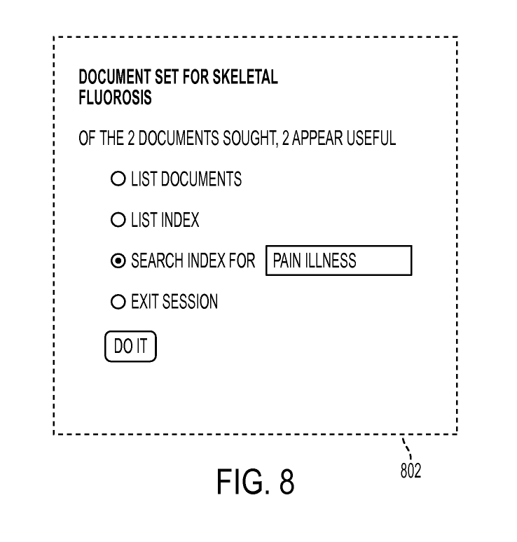

FIG. 8 shows, on a screen 802, a search query interface that allows the user to search for a certain word or words in the index.

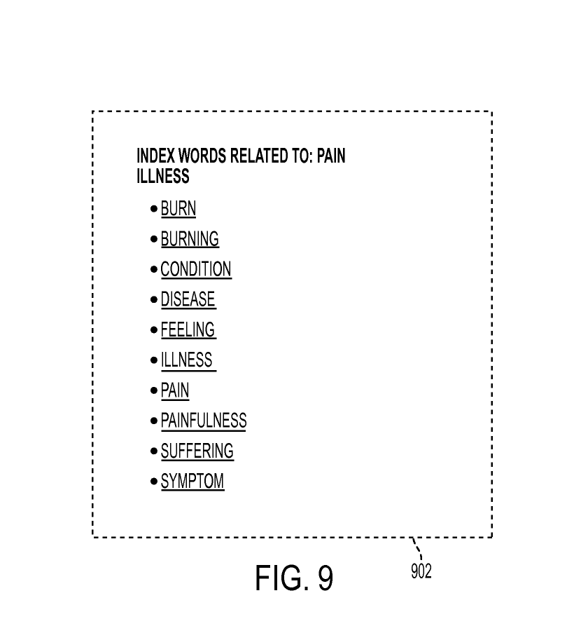

FIG. 9 shows, on a screen 902, the results of the search illustrated in FIG. 8, wherein FIG. 9 shows the words in the index related to “pain illness.”

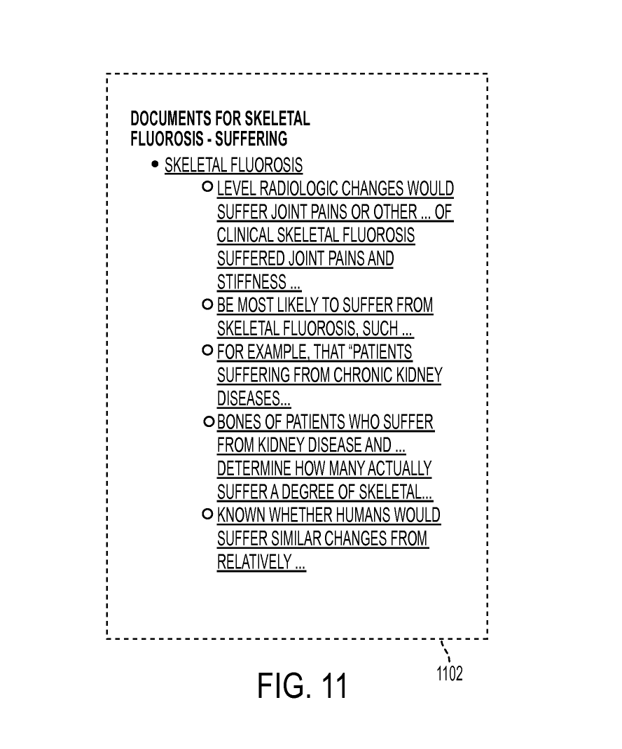

FIG. 11 shows, on a screen 1102, the results of selecting the term “suffering” from the list presented in FIG. 6. For each place in the document where the term “suffering” appears a short excerpt of the text that includes “suffering” is presented to the user. Each of these excerpts contains a hyperlink to the actual place in the document where the excerpt is located. Selecting one of these links will result in a display of the section of the document from where the excerpt is taken.

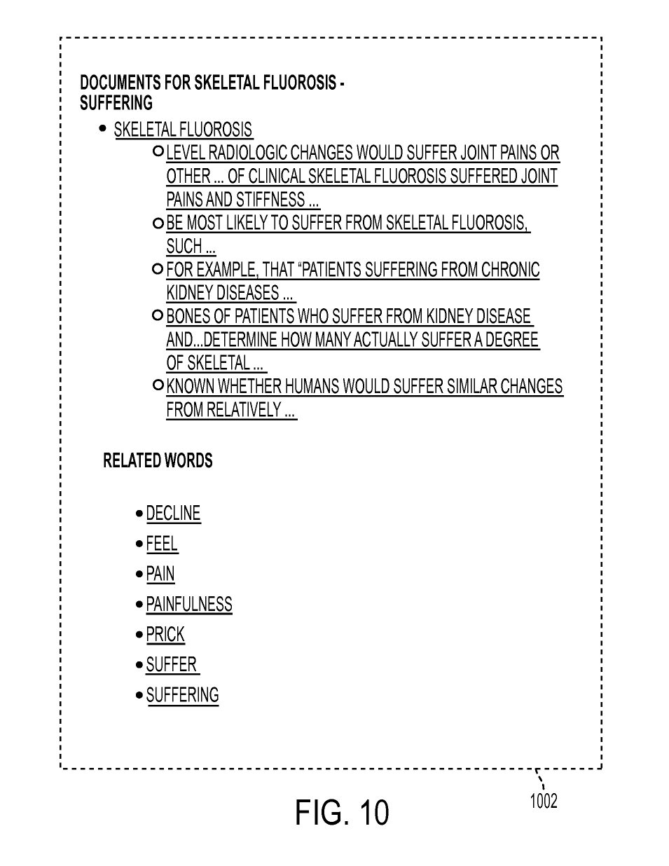

FIG. 10 shows, on a screen 1002, a list of words (Related Words), in this case synonyms of “suffering” that appear in the document set. A user may now select one of these related words to access parts of the document where the selected word appears.

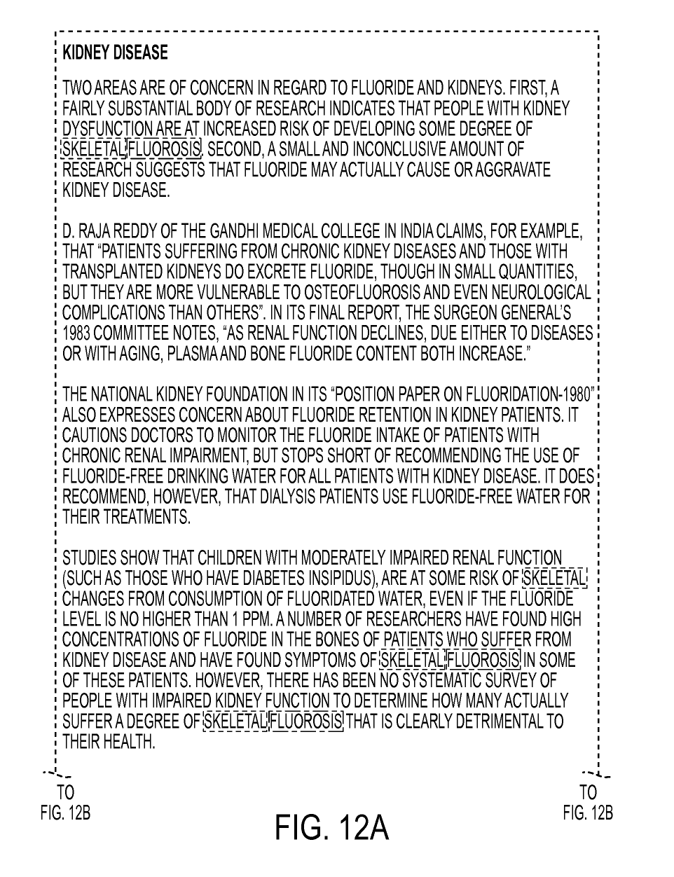

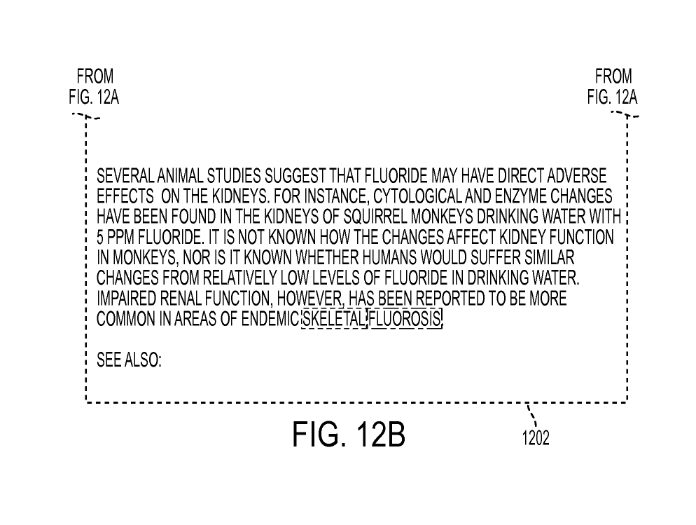

FIG. 12 shows, on a screen 1202 when an excerpt from FIG. 11 is selected from the screen 1102 of FIG. 11. The screen 1202 contains the selected reference.

As described above, a method for augmenting an index for a set of documents may obtain a word from a user; generate a list of words that are related to the obtained word, the list of words being related based upon a predefined relationship; select, from the generated list of words, a set of words that appear in the index for the set of documents; present the words in the selected set of words; and enable the user to select one or more of the words in the list of words to facilitate a search of the set of documents.

The word obtained from the user may be from an existing index for the set of documents or related to a topic of interest.

The method may generate an index for the set of documents.

The predefined relationship may proscribe words that are: synonyms of the word obtained from the user; antonyms of the word obtained from the user; hypernyms of the word obtained from the user; meronyms of the word obtained from the user; holonyms of the word obtained from the user; troponyms of the word obtained from the user; related to the word obtained from the user by entailment; and/or homophones of the word obtained from the user.

The words in the selected words may include hyperlinks to places in the document where the words occur. The presented words may provide access to associated index entries. The index entries may be hyperlinks to places in the document where the words occur.

Moreover, as described above, a computer readable recording medium may contain a set of instructions to cause a computer system to perform a search on an electronic document by obtaining a word from a user; generating a list of words that are related to the obtained word, the list of words being related based upon a predefined relationship; selecting, from the generated list of words, a set of words that appear in an index of the document set; presenting the words in the selected set of words; and enabling the user to select one or more of the words in the list of words to facilitate a search of the set of documents.

The predefined relationship may proscribe words that are: synonyms of the word obtained from the user and/or homophones of the word obtained from the user.

The computer system may generate an index of the document or present the words in the selected set of words along with hyperlinks to the location in the document where the words occur.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method for augmenting an index for a set of documents, comprising:
obtaining a word from a user;
generating a list of words that are related to the obtained word, the list of words being related based upon a predefined relationship;
selecting, from the generated list of words, a set of words that appear in the index for the set of documents;
presenting the words in the selected set of words; and
enabling the user to select one or more of the words in the list of words to facilitate a search of the set of documents.

2. The method of claim 1, wherein the word obtained from the user is from an existing index for the set of documents.

3. The method of claim 1, wherein the word obtained from the user is related to a topic of interest.

4. The method of claim 2, further comprising:
generating an index for the set of documents.

5. The method of claim 1, wherein the predefined relationship proscribes words that are synonyms of the word obtained from the user.

6. The method of claim 1, wherein the predefined relationship proscribes words that are antonyms of the word obtained from the user.

7. The method of claim 1, wherein the predefined relationship proscribes words that are hypernyms of the word obtained from the user.

8. The method of claim 1, wherein the predefined relationship proscribes words that are meronyms of the word obtained from the user.

9. The method of claim 1, wherein the predefined relationship proscribes words that are holonyms of the word obtained from the user.

10. The method of claim 1, wherein the predefined relationship proscribes words that are troponyms of the word obtained from the user.

11. The method of claim 1, wherein the predefined relationship proscribes words that are related to the word obtained from the user by entailment.

12. The method of claim 1, wherein the predefined relationship proscribes words that are homophones of the word obtained from the user.

13. The method of claim 1, wherein the words in the selected words comprise hyperlinks to places in the document where the words occur.

14. The method of claim 1, wherein the presented words provide access to associated index entries.

15. The method of claim 14, wherein the index entries are hyperlinks to places in the document where the words occur.

16. A computer readable recording medium, the recording medium containing a set of instructions, the instructions causing a computer system to perform a search on an electronic document by:
obtaining a word from a user;
generating a list of words that are related to the obtained word, the list of words being related based upon a predefined relationship;
selecting, from the generated list of words, a set of words that appear in an index of the document set;
presenting the words in the selected set of words; and
enabling the user to select one or more of the words in the list of words to facilitate a search of the set of documents.

17. The computer readable recording medium of claim 16, wherein the predefined relationship proscribes words that are synonyms of the word obtained from the user.

18. The computer readable recording medium of claim 16, wherein the predefined relationship proscribes words that are homophones of the word obtained from the user.

19. The computer readable recording medium of claim 16 wherein the computer system generates an index of the document.

20. The computer readable recording medium of claim 16, wherein the computer system presents the words in the selected set of words along with hyperlinks to the location in the document where the words occur.
